(19) United States
(12) Patent Application Publication
(10) Pub. No.: US 2010/0214070 A1
(43) Pub. Date: Aug. 26, 2010

(54) System and Method for Tracking Items

(76) Inventors: Susan Ramsay, Toronto (CA); Robert Mingov, Thornhill (CA)

Correspondence Address: Steven L. Schmid, 1824 Hickory Trace Dr., Fleming Island, FL, 32003, US

(21) Appl. No.: 12/711,198

(22) Filed: Feb. 23, 2010

Related U.S. Application Data
(60) Provisional application No. 61/154,592, filed on Feb. 23, 2009.

(51) Int. Cl. H04Q 5/22

(52) U.S. Cl. 340/10.1

(57) ABSTRACT

Disclosed is an on demand system and method for reusable asset tracking system using RFID tags. The system enables both individuals and companies to track their tagged assets in a customized manner. The asset owners may choose to track only a portion of their assets for a certain time period or for a certain location. The flexibility to limit tracking allows user to design and control cost for service. The system enables a pay per use or pay per service option in the tracking of assets using RFID technology.

### RELATED APPLICATION

This application relies upon U.S. Provisional Application Ser. No. 61/154,592 filed Feb. 23, 2009, the content of which is hereby incorporated in its entirety.

### TECHNICAL FIELD

The present invention relates generally to radio frequency identification (RFID) systems, and more specifically to a method of providing on demand tracking of reusable assets using RFID technology.

### BACKGROUND

Presently, bar codes containing a Universal Product Code (“UPC”) have become a nearly ubiquitous feature of modern life. The vast majority of products, as well as packages, containers and other elements in the stream of commerce now bear a bar code to allow for convenient tracking and inventory control.

However, bar codes have some drawbacks. Bar codes are “read only,” in that they are merely a printed set of machine-readable parallel bars that cannot be updated. Bar codes cannot transmit information, but instead must be read by a scanner. Bar codes must be scanned within a relatively short distance and must be properly oriented for the bar code to be read.

“Smart labels,” generally implemented by RFID tags, have been developed in an effort to address the shortcomings of bar codes and add greater functionality. RFID tags have been used to keep track of items such as airline baggage, items of clothing in a retail environment, cows and highway tolls.

An RFID tag includes a small antenna operatively connected to a microchip. For example, in the UHF band, the tag antenna can be just several inches long and can be implemented with conductive ink or etched in thin metal foil on a substrate of the microchip. Further, each tag can be an active tag powered by a durable power source such as an internal battery, or a passive tag powered by inductive coupling, receiving induced power from RF signals transmitted by an RFID reader. For example, an RFID reader may transmit a continuous unmodulated RF signal (i.e., a continuous wave, CW) or carrier signal for a predetermined minimum period of time to power a passive tag. The volume of space within which a reader can deliver adequate power to a passive tag is known as the power coupling zone of the reader.

The internal battery of active tags may be employed to power integrated environmental sensors, and to maintain data and state information dynamically in an embedded memory of the tag. Because passive tags do not have a durable power source, they do not include active semiconductor circuitry and must therefore maintain data and state information statically within its embedded memory. In addition, passive tags have an essentially unlimited life span, while the life span of active tags is typically limited by the lifetime of the internal battery, which in some implementations may be replaceable.

The RFID tag may be activated by a magnetic field generated by an RFID reader. The tag's antenna picks up the magnetic signal. Conventional RFID tags are passive and are generally configured with a particular surface area for reflecting back the magnetic signal at a particular modulation. That is, RFID tag modulates the signal according to information coded in surface area and reflects the modulated signal back to the RFID reader.

RFID tags use the Electronic Product Code (“EPC” or “ePC”) format for encoding information. An EPC code includes variable length bits of information (common formats are 64, 96 and 128 bits), which allows for identification of individual products as well as associated information. EPC includes header 130, EPC Manager field, Object class field and serial number field. EPC Manager field contains manufacturer information. Object class field includes a product's stock-keeping unit (“SKU”) number. Serial number field is a 40-bit field that can uniquely identify the specific instance of an individual product i.e., not just a make or model, but also down to a specific “serial number” of a make and model.

In general, existing RFID tags are passive filters that represent a sequence of numbers based on the frequencies they reflect. Each item's RFID tag bounces back a certain frequency that corresponds to the item's identification. Conventional RFID tags have specific patterned surface areas that are designed to reflect specific frequency ranges. Thus, when a reader sweeps within a plurality of different frequency ranges, the reader will receive a reflected signal when a particular RFID tag matches one of the frequency ranges. The obtained reflected signal's particular frequency modulation then corresponds to particular information, such as serial and model number, for a particular RFID tag.

Unfortunately, the implementation of such RFID systems requires a substantial investment in both software and in equipment for both large and small assets. Additionally, users need to invest in such a capital outlay even though they will need such tracking for a short time or for only a portion of their assets.

Thus, what is needed is a process and method capable of providing a customized asset tracking system for a user's particular needs.

### SUMMARY

The present system and method is an on demand reusable asset tracking system using RFID tags. The system enables both individuals and companies to track their tagged assets in a customized manner. The asset owners may choose to track only a portion of their assets for a certain time period or for a certain location. Asset owners may further choose to only track selected types of assets and numbers. The flexibility to limit tracking allows user to design and control cost for service. Essentially, the system enables a pay per use or pay per service option in the tracking of assets using RFID technology.

In greater detail, the system for on demand reusable asset tracking includes registering a plurality reusable asset owners and acquiring asset data of the reusable asset owner of the assets to be tagged. Additionally tracking parameters set by the reusable asset owner are acquired. Furthermore, encoded ID data uniquely associated with the acquired data is generated and the RFID tag ID uniquely associated with each of plurality of RFID tagged assets to which an RFID tag is attached.

The system also includes receiving an RFID tag ID and an RFID tag reader ID from an RFID tag reader having a coverage zone in which the RFID tag is located. A signal is then transmitted containing the RFID tag ID to a data server and the server is updated with location information for one or more of the plurality of RFID tagged assets as provided from the RFID tag reader. In an embodiment only a select number of tagged assets can be tracked based upon the parameters set by the reusable asset owner at any given moment and report can be generated reporting the location and movement of selected assets.

A further embodiment includes a computer program product for combination in a data server. The computer program product includes a computer readable medium having stored within a computer executable instructions for tracking and generating report data related to radio frequency identification (RFID) tag setting. The computer readable instructions when executed to perform various steps in implementing the present system.

The computer program registers reusable asset owners and acquires asset data of the reusable asset owner of the assets to be tagged. The program further acquires tracking parameters set by the reusable asset owner and generates encoded ID data uniquely associated with the acquired data, whereby the encoded data is used for printing or encoding RFID tags. The program additionally stores the RFID tag ID uniquely associated with each of plurality of RFID tagged assets to which an RFID tag is attached. The program further receives an RFID tag ID and an RFID tag reader ID from an RFID tag reader having a coverage zone in which the RFID tag is located, wherein the RFID tag is configured to transmit a signal containing the RFID tag ID.

The program additionally updates the data server with a location information for one or more of the plurality of RFID tagged assets as provided from the RFID tag reader. The program in an embodiment tracks only a select number of tagged assets of the reusable asset owner based upon the parameters set by the reusable asset owner at any given moment. A report is lastly generated providing desired information.

In an alternative embodiment there is provided an asset tracking and management system. The system includes a computer program product for combination in a data server. The computer program product includes a computer readable medium with computer executable instructions for tracking and generating report data related to a radio frequency identification (RFID) tag setting.

The tracking and management system includes a plurality of assets associated with a registered reusable asset owner. A plurality of radio frequency identification (RFID) tags is respectively attached to a corresponding plurality of assets wherein each RFID tag is configured to transmit tag ID uniquely associated in the data server with asset data associated with the registered asset owner describing the corresponding owned asset. A RFID tag reader is configured to receive a radio transmission containing the tag ID and transmitted to the tag ID with an RFID tag reader ID to the data server.

In response to receipt of the tag ID and the RFID tag reader ID from the RFID tag reader the data server determines location information for the asset corresponding to the tag ID by recognizing the corresponding asset is within a RF coverage zone of the RFID tag reader. Finally a device is connected to the data server via a network and configured to receive asset owner selected report parameters, wherein based on the user-selected report parameters, the data server is configured to generate and transmit report data to the client device to be displayed.

### DRAWING

In the Drawing

FIG. 1 is a flow chart of the system showing the steps of the on demand reusable asset tracking system.

### DETAILED DESCRIPTION

Disclosed is an on demand system and method for reusable asset tracking system using RFID tags. The system enables both individuals and companies to track their tagged assets in a customized manner. Asset owners may choose to track only a portion of their assets for a certain time period or for a certain location. The flexibility to limit tracking allows user to design and control cost for service. Essentially, the system enables a pay per use or pay per service option in the tracking of assets using RFID technology.

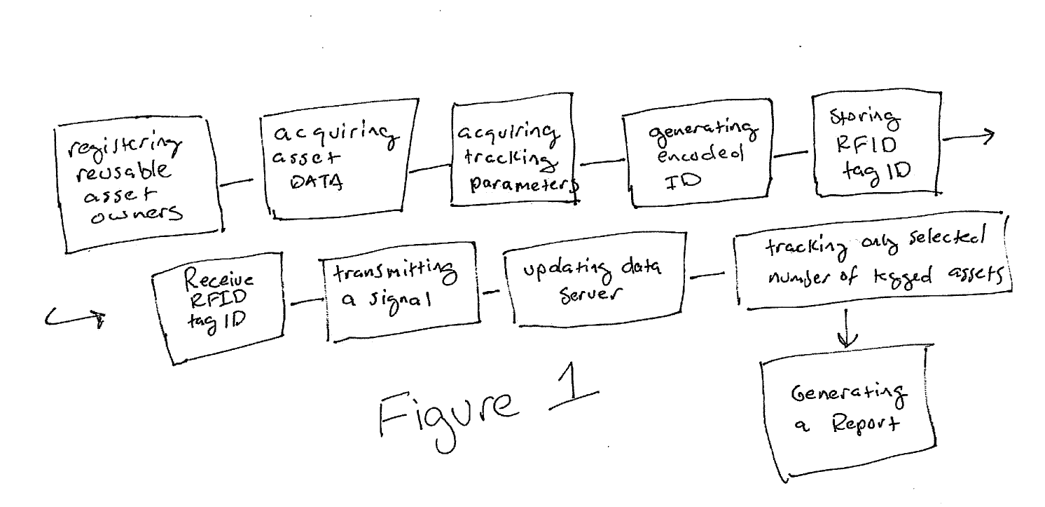

A shown in FIG. 1, the system for on demand reusable asset tracking includes registering a plurality reusable asset owners and acquiring asset data of the reusable asset owner of the assets to be tagged. The system in a further embodiments may also acquire the data from other sources. The system further includes tracking parameters set by the reusable asset owner are acquired. The parameters are part of the on demand aspect of the present system. The tracking can be limited by the user/owner of the assets to assets of a certain type, location or movement. Additional reasons for limiting tracking also exist. The encoded ID data uniquely associated with the acquired data is generated and the RFID tag ID uniquely associated with each of plurality of RFID tagged assets to which an RFID tag is attached.

The system also includes receiving an RFID tag ID and an RFID tag reader ID from an RFID tag reader having a coverage zone in which the RFID tag is located. A signal is then transmitted containing the RFID tag ID to a data server and the server is updated with location information for one or more of the plurality of RFID tagged assets as provided from the RFID tag reader. In an embodiment only a select number of tagged assets can be tracked based upon the parameters set by the reusable asset owner at any given moment and report can be generated reporting the location and movement of selected assets.

The present on demand RFID-based assets tracking system allows owners and user service requestors to track their assets when, where and how long the asset is needed. The flexibly defines and controls associated cost of tracking service based on the duration of tracking, number of assets tracked, and number of assets moved. Additionally, costs are controlled by different variations such as assets requested to be tracked and moved assets not requested to be tracked, but moved assets requested to be tracked and moved.

The system selects and instructs what assets to start or stop tracking out of the registered (for tracking service) assets. Additionally, the system proves access to the full history of all requests for tracking and access to the history of asset movements. Furthermore, control and administer access is provided to set on/off request-for-tracking and control and administer printing rights.

In further detail, the system provides an implementation of an on-demand RFID-based assets tracking as web service in an embodiment implementing a pay-per-use for RFID-based assets tracking system.

In an embodiment, the system includes a heterogeneous RFID environment. A heterogeneous system is one that can work with active, passive, or a combination of the two. RFID systems by way of example and not limitation include readers, tags, printers (for passive tags), and encoders (for active tags) at the same time. The system can be deployed at any site, including far from server/software. The physical readers do not need to be at the same geographic location as the server/software.

The software portion of the present system functions in part as a communicator reader agent in an embodiment that may act as an extension of physical reader. In the case of a passive reader the software acts as an aggregator of read-data and then passes the data to the server. The software aggregates data coming through specified ports, and applies additional filtrations and pushes data to the server function.

One difference between active and passive systems is that active RFID systems do not conform to EPC standards. Also active tags can do more than just send their IDs to readers. Active tags can contain sensors such as motion sensors, temperature sensors, and light sensors, so tag data will typically include more than just the tag's ID. Also, they can include LEDs and sound emitters. Active tags can also receive commands and send responses to commands. Active tags can be controlled in many ways by commands sent from the readers. Usually space allocated for a tag ID is limited and not long enough to store ID according to EPC standards.

In the case of an active system, the software portion of the system does more than a passive system. The software may use in an embodiment a USB to serial port interface. The readers are connected to PC/laptop having the software installed on it, thus in this embodiment the software listens to a specified serial COM port. Because of differences in libraries between Windows and Linux systems used to reads from a serial COM port, the software may have two types of download for installation.

In an embodiment, tag data can be communicated to the server software using standard web services over LAN and WAN. The software communicator can hide the implementation of hardware-specific details from the rest of the system. The software can parse all supported tag-encodings, and convert such into Java objects and XML messages which can be understood by other modules in the system.

The software can communicate and report RFID tag activity via web-services as events that can be handled by applications. Of course there can be more than one reader in the system, so that two readers may receive the same transmissions from the same RFID tags, wherein the software can detect and filter these duplicate reads. Data transmitted within the present system can be done with such encryption as the WS-Security standard and public/private key cryptography. Smart data-buffering and thread management can be used to allow stable data collection and transmission. The system may send and receive date from and to SOAP web services over LAN and WAN.

The server can maintain complete history of tracking, aggregates tracking data so that it can be consolidated and reports can be generated. The system is designed to be a multi-tenant application, with no limit to number of owners and their assets in the systems. In the registration and setup of the reusable asset a set of services is provided to setup operation of the system. The setup services application allows entry of reusable asset owner's attributes. The setup can be used by the system to generate and assign a company ID to the owner.

The assets in the system at any given point of time have an owner. The generated company ID is used in generating and encoding RFID for the owner's assets. In case of reusable assets the concept of an owner is fundamental. Regardless where the assets are currently located, the assets have an owner. In a further embodiment the current system can manage a chain of custody functionality. This functionality indicates at any point of time in whose custody the asset is currently with. To utilize the chain of custody, an additional setup is required, such as partner setup and other attributes of parties involved in the chain. Registration may be made via web screens.

The registration data is posted to the system in the software. The system may serve other requests to set and acquire data. In the registration of the data, the owner can define product types (SKU) of assets that should be tracked. The user or owner can select from existing list or create new product types (SKU). The registration of the data can further define how many tags of selected product type (SKU) and selected encoding standard can be ordered.

The system can support by way of example and limitation may include all 96-bit-based EPC encoding standards such as SGTIN-96, SSCC-96, SGLN-96, GRAI-96 and GIAI-96 for passive tags and TagSense ZT10 and ZT50 for active tags. In the ordering of the based encoding the owner's request can be provide by such means as a generated file with encoded data ready to be printed using RFID printer (for passive tags) and/or shipment of pre-printed/pre-encoded ready to use tags (passive and active tags).

After registration, the registered assets can be ready for tracking. Regarding the ready to-be-tracked assets, the owner can activate some or all of the tags Services are provided to register, un-register, set tracking on or off for one, group, or all of those listed. In the system a flexible setup of rules of what and when to track can be provided. “When” can be defined by setting start and/or end time and “when” can be defined by location. For example, a user or owner can define location(s) as “no-track zones”. Storage or destination (ship-to) locations can be set as “no-track zones” for order-items or some of them.

The flexibility of PSI RFID tracking services brings to another fundamental concept of Pay-per-Use or Pay-per-Service. This feature makes assets RFID-tracking a real service and allows users to design and control cost for service requested.

The zoning the present system can be designed per EPC ALE 1.0 specification in an embodiment. The zoning can be designed to be used in heterogeneous RFID environments, where areas of interest may be monitored by arbitrary sets of readers with any number of antennas. A Logical Reader in the system can have an arbitrary hierarchical or linear structure or mix both.

In the determination of the movement of the tagged assets Capture Movement Directionality (CMD) for passive RFID systems can be used. CMD is defined as a setup of minimum two not completely overlapping Reading Zones (RZ1 and RZ2). Where RZ1 associated with one RF antenna (read point) and RZ2 associated with another RF antenna. Each Area can have multiple CMD points that define Perimeter of the area. The idea behind this setup is to have a continuity of readings to be able to identify direction of movement of RFID objects.

In the use of active RFID tags the software may conform an active tag to be compliant to EPC ALE standards. For such active systems, the software implements RF beacons that can serve as location identifiers. To utilize ALE standards for the active tag system, beacons are introduced to ALE system in ALE' s terminology. Beacons are defined and implemented as Read Points (using ALE terminology).

While Applicant has set forth embodiments as illustrated and described above, it is recognized that variations may be made with respect to disclosed embodiments. Therefore, while the invention has been disclosed in various forms only, it will be obvious to those skilled in the art that many additions, deletions and modifications can be made without departing from the spirit and scope of this invention, and no undue limits should be imposed except as set forth in the following claims.

What is claimed is:

1. A computer program product for combination in a data server, the computer program product including a computer readable medium having stored thereon computer executable instructions for tracking and generating report data related to a radio frequency identification (RFID) tag setting, the computer readable instructions when executed to perform the steps comprising:
registering a plurality reusable asset owners;
acquiring asset data of the reusable asset owner of the assets to be tagged,
acquiring tracking parameters set by the reusable asset owner;
generating encoded ID data uniquely associated with the acquired data, whereby the encoded data is used for printing or encoding RFID tags;
storing the RFID tag ID uniquely associated with each of plurality of RFID tagged assets to which an RFID tag is attached,;
receiving an RFID tag ID and an RFID tag reader ID from an RFID tag reader having a coverage zone in which the RFID tag is located, wherein the RFID tag is configured to transmit a signal containing the RFID tag ID;
updating the data server with a location information for one or more of the plurality of RFID tagged assets as provided from the RFID tag reader; and
tracking only a select number of tagged assets of the reusable asset owner based upon the parameters set by the reusable asset owner at any given moment; and
generating a report.

2. The computer program product of claim 1, wherein the parameters set by the assert owner include tracking tagged assets based upon the location of the tagged asset, wherein in certain zones assets are not tracked.

3. The computer program product of claim 1, wherein the parameters set by the assert owner include tracking tagged assets based upon a duration of time, wherein assets are tracked based upon a time interval entered by the reusable asset owner.

4. The computer program product of claim 1, wherein the parameters set by the assert owner include tracking tagged assets based upon a number of assets to be tracked.

5. The computer program product of claim 1, wherein the asset data includes defined product types and the number of RFID tags needed for each product type.

6. The computer program product of claim 5, wherein the parameters set by the assert owner include tracking tagged assets based upon the product type of the asset.

7. The computer program product of claim 1, further including selecting encoding standards for the RFID tags.

8. The computer program product of claim 1, wherein the RFID tags are selected from the group consisting essentially of passive RFID tags, active RFID tags and combinations thereof.

9. The computer program product of claim 1, wherein the directionality of movement of the tagged asset is tracked and wherein the parameters set by the assert owner include tracking tagged assets based upon movement of the asset.

10. The computer program product of claim 1, further including defining and implementing read points as location identifiers for active RFID tags.

11. An asset tracking and management system comprising:
a computer program product for combination in a data server, the computer program product including a computer readable medium having stored thereon computer executable instructions for tracking and generating report data related to a radio frequency identification (RFID) tag setting;
a plurality of assets associated with a registered reusable asset owner;
a plurality of radio frequency identification (RFID) tags respectively attached to a corresponding plurality of assets, each RFID tag being configured to transmit tag ID uniquely associated in the data server with asset data associated with the registered asset owner describing the corresponding owned asset;
an RFID tag reader configured to receive a radio transmission containing the tag ID, and transmits the tag ID with an RFID tag reader ID to the data server wherein, in response to receipt of the tag ID and the RFID tag reader ID from the RFID tag reader, the data server determines location information for the asset corresponding to the tag ID by recognizing the corresponding asset is within a RF coverage zone of the RFID tag reader;
a device connected to the data server via a network and configured to receive asset owner selected report parameters, wherein based on the user-selected report parameters, the data server is configured to generate and transmit report data to the client device to be displayed.

12. The asset tracking and management system of claim 11, further including defining and implementing read points as location identifiers for active RFID tags.

13. The asset tracking and management system of claim 11, wherein the parameters set by the assert owner include tracking tagged assets based upon the location of the tagged asset, wherein in certain zones assets are not tracked.

14. The asset tracking and management system of claim 11, wherein the parameters set by the assert owner include tracking tagged assets based upon a duration of time, wherein assets are tracked based upon a time interval entered by the reusable asset owner.

15. The asset tracking and management system of claim 11, wherein the parameters set by the assert owner include tracking tagged assets based upon a number of assets to be tracked.

16. The asset tracking and management system of claim 11, wherein the asset data includes defined product types and the number of RFID tags needed for each product type and wherein the parameters set by the assert owner include tracking tagged assets based upon the product type of the asset.

17. The asset tracking and management system of claim 11, wherein the RFID tags are selected from the group consisting essentially of passive RFID tags, active RFID tags and combinations thereof.

18. The computer program product of claim 11, wherein the directionality of movement of the tagged asset is tracked and wherein the parameters set by the assert owner include tracking tagged assets based upon movement of the asset.

19. An on demand reusable asset tracking system comprising:
registering a plurality reusable asset owners;
acquiring asset data of the reusable asset owner of the assets to be tagged,
acquiring tracking parameters set by the reusable asset owner;
generating encoded ID data uniquely associated with the acquired data, whereby the encoded data is used for printing or encoding RFID tags;
storing the RFID tag ID uniquely associated with each of plurality of RFID tagged assets to which an RFID tag is attached,;
receiving an RFID tag ID and an RFID tag reader ID from an RFID tag reader having a coverage zone in which the RFID tag is located,
transmitting a signal containing the RFID tag ID to a data server;
updating the data server with a location information for one or more of the plurality of RFID tagged assets as provided from the RFID tag reader; and
tracking only a select number of tagged assets of the reusable asset owner based upon the parameters set by the reusable asset owner at any given moment; and
generating a report.

20. The on demand reusable asset tracking system of claim 19, wherein the parameters set by the assert owner include tracking tagged assets based upon the location of the tagged asset, wherein in certain zones assets are not tracked.

21. The on demand reusable asset tracking system of claim 19, wherein the parameters set by the assert owner include tracking tagged assets based upon a duration of time, wherein assets are tracked based upon a time interval entered by the reusable asset owner.

22. The on demand reusable asset tracking system of claim 19, wherein the parameters set by the assert owner include tracking tagged assets based upon a number of assets to be tracked.

23. The on demand reusable asset tracking system of claim 19, wherein the asset data includes defined product types and the number of RFID tags needed for each product type and wherein the parameters set by the assert owner include tracking tagged assets based upon the product type of the asset.

24. The on demand reusable asset tracking system of claim 19, wherein the RFID tags are selected from the group consisting essentially of passive and active RFID tags and combinations thereof and defining and implementing read points as location identifiers for active RFID tags.

25. The on demand reusable asset tracking system of claim 19, wherein the directionality of movement of the tagged asset is tracked and wherein the parameters set by the assert owner include tracking tagged assets based upon movement of the asset.
